(19) United States
(12) Patent Application Publication
(10) Pub. No.: US 2013/0162812 A1
(43) Pub. Date: Jun. 27, 2013

(54) SPOT DETECTING SYSTEM FOR CAMERA MODULE AND SPOT DETECTING METHOD THEREOF

(71) Applicant: CHIUNG-SHENG WU, Tu-Cheng (TW)

(72) Inventor: CHIUNG-SHENG WU, Tu-Cheng (TW)

(73) Assignee: HON HAI PRECISION INDUSTRY CO., LTD., Tu-Cheng (TW)

(21) Appl. No.: 13/606,306

(22) Filed: Sep. 7, 2012

(30) Foreign Application Priority Data
Dec. 21, 2011 (TW) 100147855

(51) Int. Cl. H04N 7/18

(52) U.S. Cl. 348/125; 348/E07.085

(57) ABSTRACT

A spot or anomaly detecting system include a camera module and a signal processor. The camera module captures an image. The signal processor includes an area partition module, a brightness detection module, and a calculating module. The area partition module receives the image, and divides the image into a plurality of detecting areas. The brightness detection module reads the brightness of the plurality of detecting areas. The calculating module has a critical brightness ratio being pre-stored, and calculates a proportionality of the brightness of each test point relative to the brightness of the detecting area immediately around the test point, and then determining the test point to be a spot or not by contrasting the calculated proportionality against the critical brightness ratio. If the calculated proportionality is not more than the critical brightness ratio, the test point is deemed an anomaly.

### BACKGROUND

1. Technical Field

The present disclosure relates to spot detecting systems, particularly to a spot detecting system for a camera module and a spot detecting method thereof.

2. Description of Related Art

Electronic devices, such as mobile phones, tablet computers, and cameras, for example, are capable of taking photos and videos via at least one camera module. Each camera module includes many components, such as a sensor and at least one lens. During assembly of the camera module, if even when a little grain of dust enters and stays on the camera module, such an imaging spot may cause an uneven chromaticity. Detecting whether the camera module has a spot found in any area, such as a particle, can be done manually, however the manual detecting of particle may easily miss a spot, and also detecting manually has a low detecting efficiency.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a block schematic view of an embodiment of a spot detecting system for capturing an image and detecting spots of the image.

FIG. 2 is an isometric view of the spot detecting system shown in FIG. 1.

FIG. 3 is a flow chart of a spot detecting method for detecting spots using the spot detecting system of the image shown in FIG. 1.

FIG. 4 is a schematic view of the image divided into a plurality of blocks by the spot detecting system shown in FIG. 1.

FIG. 5 is a schematic view of the image divided into a plurality of areas by the spot detecting system shown in FIG. 1, the plurality of areas includes a center detecting area, a pair of horizontal detecting areas, a pair of vertical detecting areas, and four corner detecting areas.

FIG. 6 is a schematic view of the horizontal detecting areas of the spot detecting system shown in FIG. 5.

FIG. 7 is a schematic view of the vertical detecting areas of the spot detecting system shown in FIG. 5.

FIG. 8 is a schematic view of the center detecting area of the spot detecting system shown in FIG. 5.

FIG. 9 is a schematic view of the corner detecting area of the spot detecting system shown in FIG. 5.

### DETAILED DESCRIPTION

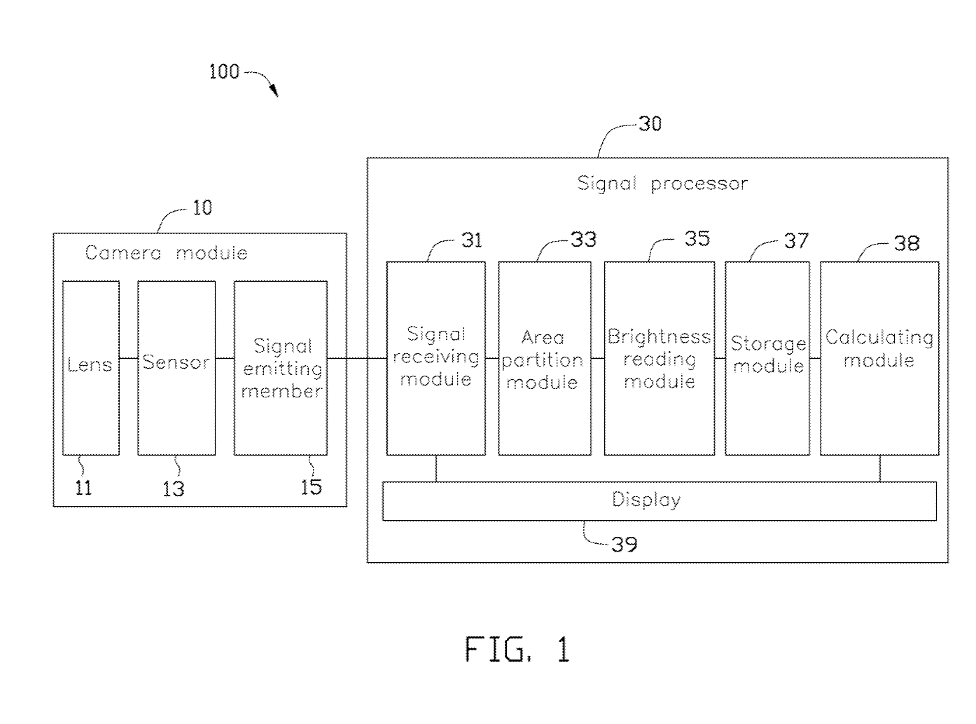

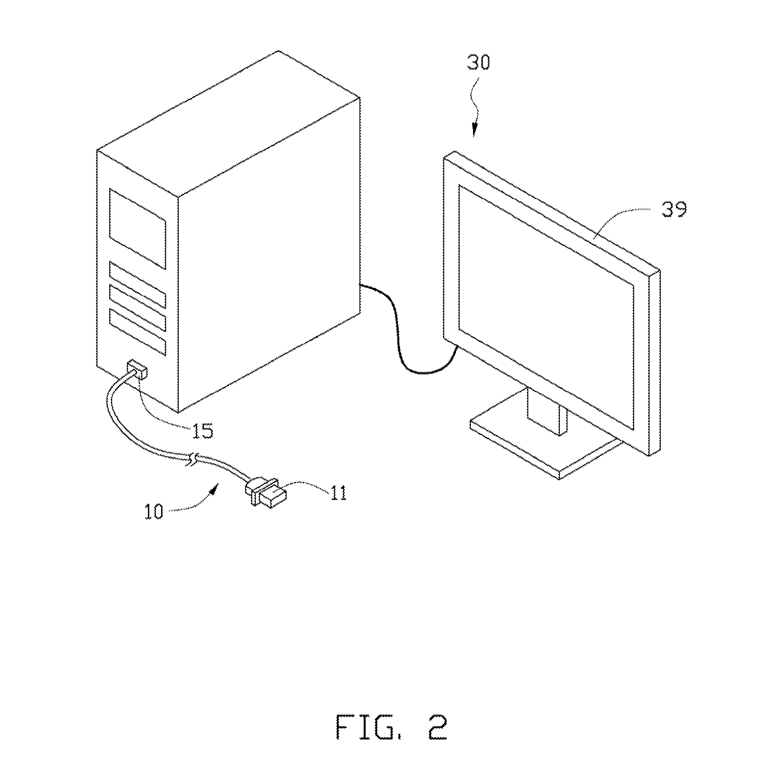

Referring to FIGS. 1 and 2, a spot detecting system 100 is shown. The spot detecting system 100 includes a camera module 10 and a signal processor 30. The camera module 10 includes a lens 11, a sensor 13, and a signal emitting member 15. The sensor 13 is located behind the lens 11, and is configured to capture images via the lens 11. The signal emitting member 15 is connected to the sensor 13 and the signal processor 30, and is configured to emit signals representing the images captured by the sensor 13, to the signal processor 30.

The signal processor 30 includes a signal receiving module 31, an area partition module 33, a brightness detection module 35, a storage module 37, and a calculating module 38. In the illustrated embodiment, the signal processor 30 is a computer, and the signal processor 30 further includes a display 39.

The signal receiving module 31 connects with the signal emitting member 15, and receives the image signals from the signal emitting member 15, and transmits the image signals to the area partition module 33. The area partition module 33 connects with the signal receiving module 31, and divides an image captured by the sensor 13 into a plurality of detecting areas. The brightness detection module 35 connects with the area partition module 33, and detect and analyzes the brightness of each detecting area. The storage module 37 connects with the brightness detection module 35, and stores the value of the brightness of each detecting area. The calculating module 38 has a critical brightness ratio pre-stored therein. The calculating module 38 reads the brightness value of a test point within a detecting area and a plurality of brightness values of the detecting areas around the test point, and calculates the proportionality of the brightness value of the test point relative to the brightness values of the detecting areas around the test point, and then judges whether the test point is a spot by contrasting the calculated proportionality with the critical brightness ratio. If the calculated proportionality is smaller than or equal to the critical brightness ratio, the test point is deemed to be a spot. If the calculated proportionality is larger than the critical brightness ratio, the test point is deemed not to be a spot. The display 39 connects with the signal receiving module 31 and the calculating module 38, and displays the image captured by the sensor 13 and the spot judged by the calculating module 38. In another embodiment, the signal processor 30 can be a single chip microcomputer or other programmable intelligent device. The signal processor 30 can add other functional modules for optimizing signal processing performance. The signal receiving module 31 can be omitted when the area partition module 33 can directly receive the image signals from the signal emitting member 15. The storage module 37 can be omitted when the brightness detection module 35 has an intrinsic memory capable of recalling the brightnesses of the detecting areas.

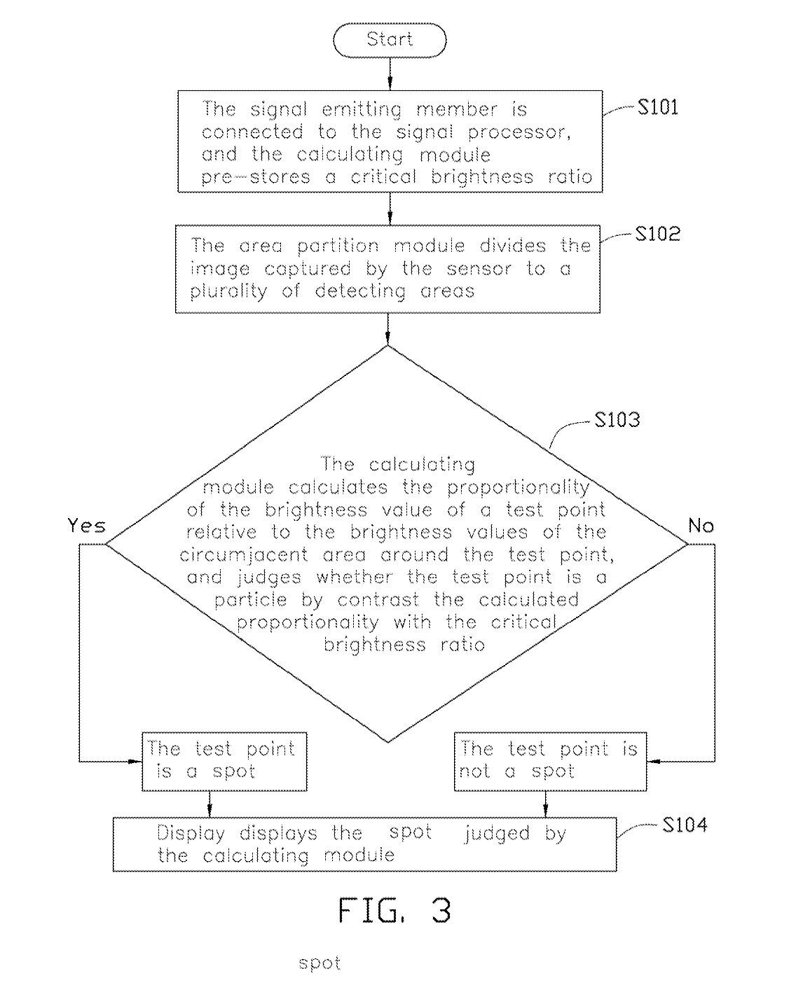

Referring to FIG. 3, a spot detecting method of the spot detecting system 100 is as follows.

Step 101, the signal emitting member 15 connects with the signal processor 30. The sensor 13 captures an image via the lens 11, and the signal emitting member 15 emits signals representing the image to the signal receiving module 31. The calculating module 38 pre-stores a critical brightness ratio Yₜ. Because it is known that absolutely even or perfect brightness of the image does not exist, the value of critical brightness ratio Yₜ approximates to 1, but is not equal to 1.

Step 102, the area partition module 33 divides the image captured by the sensor 13 into a plurality of detecting areas. The brightness detection module 35 analyzes the brightness of each detecting area. The storage module 37 stores the value of the brightness of each detecting area.

Step 103, the calculating module 38 calculates the proportionality of the brightness value of a test point relative to the brightness values of the detecting areas around the test point, and calculates whether the test point is a spot by contrasting the calculated proportionality with the critical brightness ratio Yₜ. If the calculated proportionality is not more than the critical brightness ratio Yₜ, the test point is deemed to be a spot. If the calculated proportionality is larger than the critical brightness ratio Yₜ, the test point is deemed to be not a spot.

Step 104, the display 39 displays the spots calculated by the calculating module 38.

In the illustrated embodiment, step 102 includes the following steps.

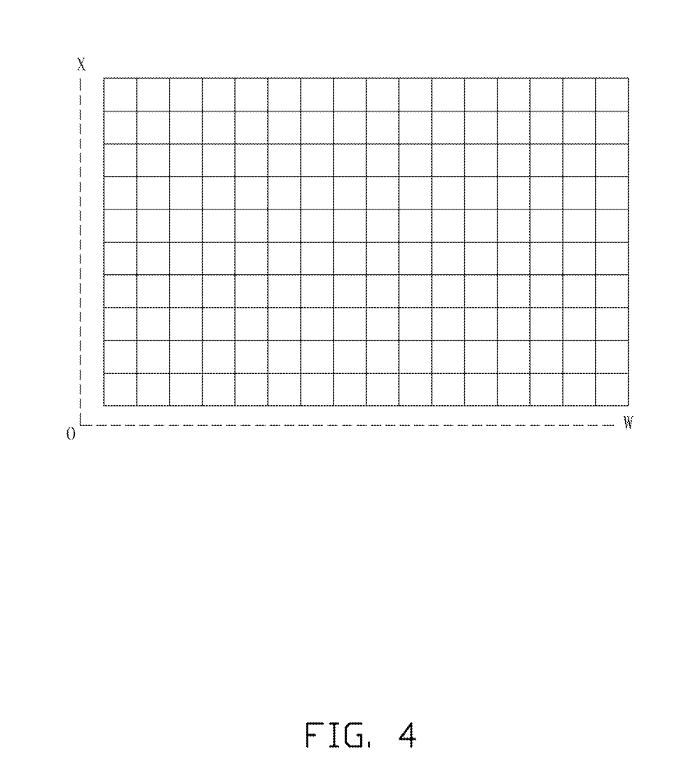

Step 1021, referring to FIG. 4, the area partition module 33 divides the image into W*X blocks. “W” is a number of horizontal blocks of the image, and “X” is a number of vertical blocks of the image. The number of horizontal blocks “W” and the number of vertical blocks “X” is established by the image size and the detecting precision of the image. In other words, the size of the detecting area is decided by the image size and the detecting precision of the image.

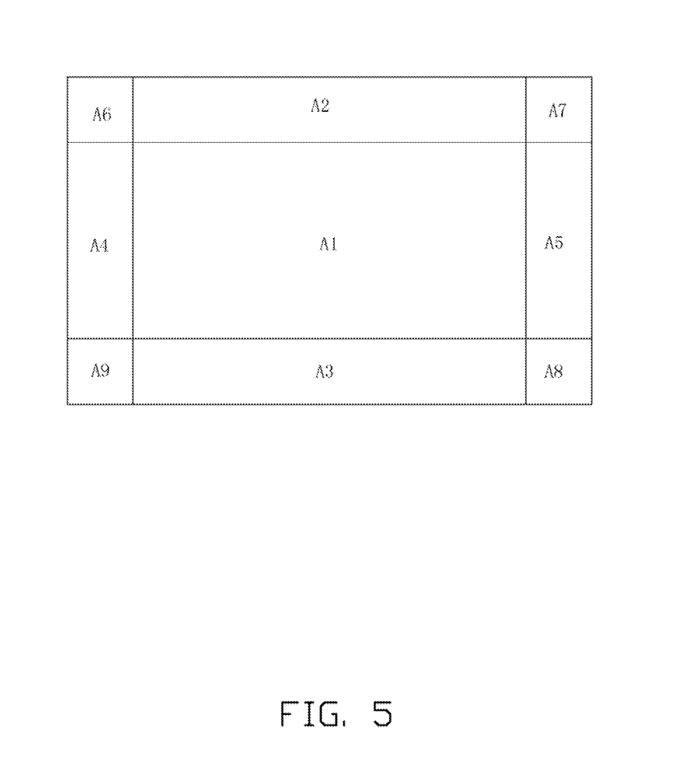

Step 1022, referring to FIG. 5, the area partition module 33 divides the W*X blocks into nine detecting areas A1˜A9. Each detecting area includes a plurality of blocks. Detecting area A1 is a center detecting area, and is located at a center portion of the image. Detecting areas A2 and A3 are the horizontally-oriented detecting areas, respectively above and below the detecting area A1. Detecting areas A4 and A5 are vertically-oriented detecting areas, on opposite sides of the center detecting area A1. Detecting areas A6, A7, A8, A9 are corner detecting areas, and are located at the four corners of the center detecting areas A1. In the illustrated embodiment, the detecting areas A4 and A5 occupy a same number of blocks, the detecting areas A2, and A3 occupy a same number of blocks, the detecting areas A6, A7, A8, A9 occupy a same number of blocks.

In the illustrated embodiment, the area partition module 33 can divide the image into a plurality of detecting areas via other dividing means, such as dividing the image according the pixels of the image.

In the illustrated embodiment, the step 103 includes the following steps.

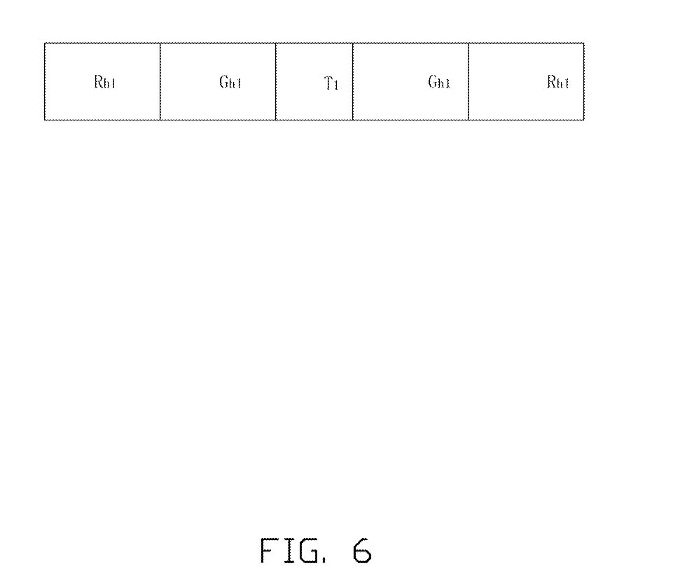

Step 1031, referring to FIG. 6, the calculating module 38 calculates the horizontal brightness of the horizontal detecting areas A2 and A3. A test point is defined as “T₁”, and the test point “T₁” is a small block within the areas A2 and A3. Because an area of a spot may be larger than an area of a block, a pair of gap areas “Gₕ₁” are defined at adjacent opposite horizontal sides of the test point “T₁”, and a pair of contrasting areas “Rₕ₁” are defined beside or next to the gap areas “Gₕ₁” away from the test point “T₁”. The number of the blocks of the gap area “Gₕ₁” is “G”, and the number of blocks of the contrasting area “Rₕ₁” is “R”. The numbers “G” and “R” are decided by the degree of precision required. The calculating module 38 reads the brightness value “Y₁” of the test point “T₁”, and reads the average brightness value “Yₕ₁” of the contrasting areas “Rₕ₁” by skipping the gap areas “Gₕ₁”. The value of “Yₕ₁” can be easily calculated by means of the mathematical functional relationships, as shown in Equation 1 below:

$${Y}_{h 1} = \frac{1}{2 R} {\sum }_{i = 1}^{2 R} {Y}_{i} , \qquad [ 1 ]$$

in which the Yᵢ presents a brightness value of a number “i” block. The calculating module 38 contrasts the brightness value “Y₁” of the test point “T₁” relative to the average brightness value “Yₕ₁” of the contrasting areas “Rₕ1” to achieve a proportionality defined as “Pₕ₁”, and the value of “Pₕ₁” can be easily calculated by means of the mathematical functional relationships, as shown in Equation 2 below:

$${P}_{h 1} = \frac{Y}{{Y}_{h}} * 100 \% . \qquad [ 2 ]$$

The calculating module 38 compares the proportionality “Pₕ₁” relative to the pre-stored critical brightness ratio “Yₜ”, and if the proportionality “Pₕ₁” is not more than the critical brightness ratio “Yₜ”, the test point “T₁” is deemed to be a spot, and if the proportionality “Pₕ₁” is larger than the critical brightness ratio “Yₜ”, the test point “T₁” is deemed to be not a spot.

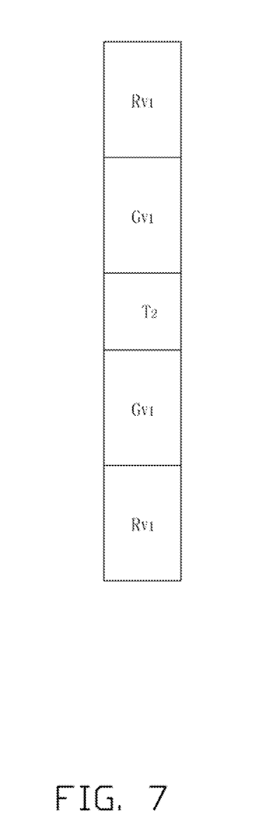

Step 1032, referring to FIG. 7, the calculating module 38 calculates the vertical brightness of the vertically-oriented detecting areas A4 and A5. A test point is defined as “T₂”, and the test point “T₂” is a small block within the detecting areas A4 and A5. Because an area of a spot may be larger than an area of a block, a pair of gap areas “Gᵥ₁” are defined at adjacent opposite sides of the test point “T₂”, and a pair of contrasting areas “Rᵥ₁” are defined beside the gap area “Gᵥ₁” away from the test point “T₂”. The calculating module 38 reads the brightness value “Y₂” of the test point “T₂”, and reads the average brightness value “Yᵥ₁” of the contrasting areas “Rᵥ₁” by skipping over the gap areas “Gᵥ₁”. The value of “Yᵥ₁” can be easily calculated by means of the mathematical functional relationships, as shown in Equation 3 below:

$${Y}_{v 1} = \frac{1}{2 R} {\sum }_{i = 1}^{2 R} {Y}_{i} , \qquad [ 3 ]$$

in which the Yᵢ presents a brightness value of a number “i” block. The calculating module 38 contrasts the brightness value “Y₂” of the test point “T₂” relative to the average brightness value “Yᵥ₁” of the contrasting areas “Rᵥ₁” to achieve a proportionality defined as “Pᵥ₁”, and the value of “Pᵥ₁” can be easily calculated by means of the mathematical functional relationships, as shown in Equation 4 below:

$${P}_{v 1} = \frac{Y}{{Y}_{v}} * 100 \% . \qquad [ 4 ]$$

The calculating module 38 compares the proportionality “Pᵥ₁” relative to the pre-stored critical brightness ratio “Yₜ”, and if the proportionality “Pᵥ₁” is not more than the critical brightness ratio “Yₜ”, the test point “T₂” is deemed to be a spot, and if the proportionality “Pᵥ₁” is larger than the critical brightness ratio “Yₜ”, the test point “T₂” is deemed to be not a spot.

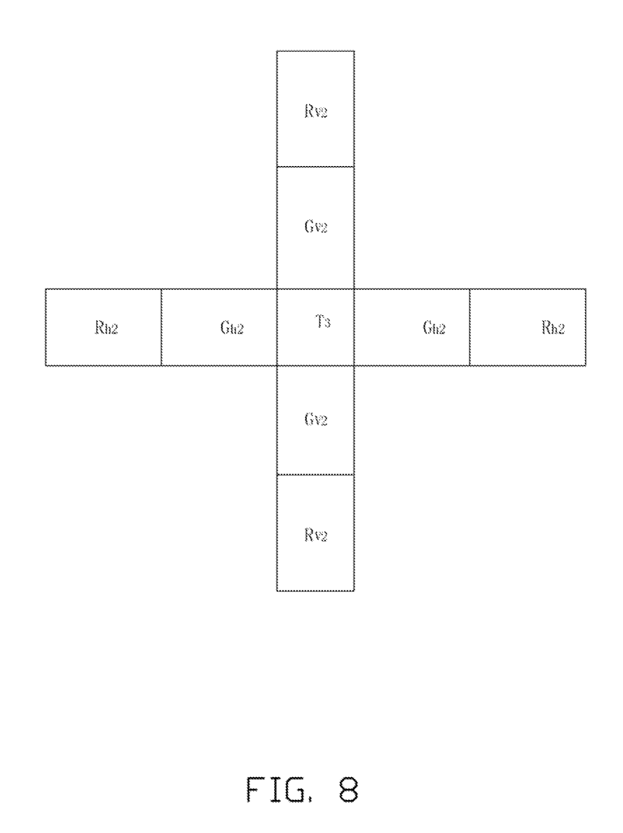

Step 1033, referring to FIG. 8, the calculating module 38 calculates the horizontal and vertical brightness of the center detecting area A1. A test point is defined as “T₃”, and the test point “T₃” is a small block in the center detecting area A1. A pair of gap areas “Gₕ₂” are defined beside the test point “T₃”, and a pair of gap areas “Gᵥ₂” are defined above and below the test point “T₃”. A pair of contrasting areas “Rₕ₂” are beside the gap areas “Gₕ₂” away from the test point “T₃”, and a pair of contrasting areas “Rᵥ₂” are defined above and below the gap areas “Gᵥ₂” away from the test point “T₃”. The calculating module 38 calculates a proportionality “Pₕ₂” of a brightness value of the test point “T₃” in contrast to an average brightness value of the horizontally-oriented contrasting area “Rₕ₂”, as done in step 1031, and calculates a proportionality “Pᵥ₂” of a brightness value of the test point “T₃” in contrast to an average brightness value of the vertically-oriented contrasting area “Rᵥ₂”, as done in step 1032. The calculating module 38 then compares the proportionalities of “Pₕ₂” and “Pᵥ₂” relative to the pre-stored critical brightness ratio “Yₜ”, and if either one of “Pₕ₂” and “Pᵥ₂” is not more than the critical brightness ratio “Yₜ”, the test point “T₃” is deemed to be a spot, and if the proportionalities of either one of “Pₕ₂” or “Pᵥ₂” is larger than the critical brightness ratio “Yₜ”, the test point “T₃” is deemed to be not a spot.

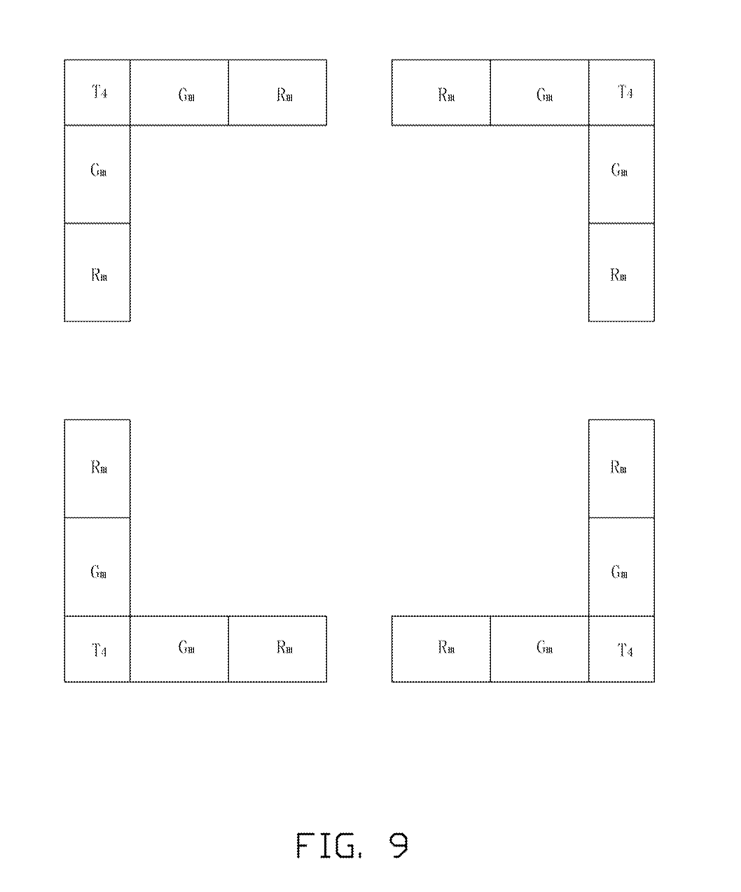

Step 1034, referring to FIG. 9, the calculating module 38 calculates the vertical brightness of the corner detecting areas A6, A7, A8 and A9. A test point is defined as “T₄”, and the test point “T₄” is a small block within the corner detecting areas A6, A7, A8 and A9. Gap areas “Gₘ” are found vertically and horizontally next to the test point “T₄”, and contrasting areas “Rₘ” are also found vertically and horizontally next to each respective gap area “Gₘ” away from the test point “T₄”. The calculating module 38 reads the brightness value “Y₄” of the test point “T₄”, and reads the average brightness value “Yₘ” of the contrasting areas “Rₘ” by skipping over the gap areas “Gₘ”. The value of “Yₘ” can be easily calculated by means of the mathematical functional relationships, as shown in Equation 5 below:

$${Y}_{m} = \frac{1}{2 R} {\sum }_{i = 1}^{2 R} {Y}_{i} , \qquad [ 5 ]$$

in which the Yᵢ presents a brightness value of a number “i” block. The calculating module 38 contrasts the brightness value “Y₄” of the test point “T₄” relative to the average brightness value “Yₘ” of the contrasting areas Rm to achieve a proportionality defined as “Pₘ”, and the value of “Pₘ” can be easily calculated by means of the mathematical functional relationships, as shown in Equation 6 below:

$${P}_{m} = \frac{Y}{Ym} * 100 \% . \qquad [ 6 ]$$

The calculating module 38 compares the proportionality of “Pₘ” against the pre-stored critical brightness ratio “Yₜ”, and if the proportionality “Pₘ” is not more than the critical brightness ratio “Yₜ”, the test point “T₄” is deemed to be a spot, and if the proportionality “Pₘ” is larger than the critical brightness ratio “Yₜ”, the test point “T₄” is deemed to be not a spot.

The calculating module 38 contrasts the brightness of every test point with the brightness of the detecting area immediately around the test point, to establish whether the test point is or is not a spot. Therefore, the spot detecting system 100 is capable of detecting all the spots in the cameral module 10 precisely and efficiently. In addition, the precision of detection can be adjusted by changing the value of the critical brightness ratio, or the number of the blocks in each gap area or contrasting area.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A spot detecting system, comprising:
a camera module for capturing an image and emitting a plurality of signals representing the image, and
a signal processor connected to the camera module, comprising an area partition module, a brightness detection module, and a calculating module connected one by one, the area partition module being capable of receiving the signals representing the image from the camera module, and dividing the image to a plurality of detecting areas, the brightness detection module being capable of reading the brightness of the plurality of detecting areas, the calculating module having a critical brightness ratio pre-stored therein, and capable of calculating a proportionality of the brightness of each test point relative to the brightness of the circumjacent area around the test point, and then judging whether the test point deemed to be a spot by contrasting the calculated proportionality with the critical brightness ratio, if the calculated proportionality being smaller than or equal to the critical brightness ratio, the test point being deemed to be a spot, otherwise the test point deemed not to be a spot.

2. The spot detecting system of claim 1, wherein the camera module comprises a signal emitting member, the signal processor further comprises a signal receiving module connected to the area partition module, the area partition module receives the signals from the signal emitting member via the signal receiving module.

3. The spot detecting system of claim 1, wherein the signal processor further comprises a storage module connected to the brightness detection module and the calculating module, for storing the brightness value of the plurality of detecting areas read by the brightness detection module, the calculating module obtains the brightness value for calculating the proportionality of the brightness values from the storage module.

4. The spot detecting system of claim 2, wherein the signal processor further comprises a display connected to the signal receiving module and the calculating module, the display displays the image and the spot judged by the calculating module.

5. The spot detecting system of claim 2, wherein the camera module further comprises a lens and a sensor located behind the lens, the signal emitting member is connected to the sensor, the sensor captures the image via the lens, and transmits the signals to the signal emitting member.

6. The spot detecting system of claim 1, wherein the signal processor is a programmable intelligent device.

7. The spot detecting system of claim 6, wherein the signal processor is a computer.

8. A spot detecting method using the spot detecting system of claim 1, for testing whether a spot exists in the lens module, comprising:
connecting the camera module to the signal processor, and pre-storing a critical brightness ratio by the calculating module;
dividing the image captured by the camera module to a plurality of detecting areas using the area partition module; and
calculating the proportionality of the brightness value of a test point in the detecting areas relative to the brightness values of the circumjacent area around the test point, and judging whether the test point is a spot by contrasting the calculated proportionality with the critical brightness ratio using the calculating module, if the calculated proportionality being smaller than or equal to the critical brightness ratio, the test point being deemed to be a spot, otherwise the test point is deemed to be not a spot.

9. The spot detecting method of claim 8, wherein dividing the image captured by the camera module to the plurality of detecting areas using the area partition module comprising:
dividing the image to a plurality of blocks using the area partition module; and
dividing the image to a plurality of detecting areas using the area partition module, and each detecting area comprising the plurality of blocks.

10. The spot detecting method of claim 9, wherein the number of the detecting areas is nine, the detecting areas comprises a center detecting area, a pair of horizontally-oriented detecting areas, a pair of vertically-oriented detecting areas, and four corner detecting areas, the pair of horizontally-oriented detecting areas is located above and below the center detecting area, the pair of vertically-oriented detecting areas is located besides the center detecting area, the corner detecting areas are located at four corners of the center detecting area.

11. The spot detecting method of claim 10, wherein a gap area is defined around the test point, and a contrasting area is defined beside the gap area away from the test point, the gap area and the contrasting area both occupy at least one block, the calculating module calculates the proportionality of the brightness value of the test point relative to the brightness values of the contrasting area, and judges whether the test point is a spot by contrasting the calculated proportionality with the critical brightness ratio.

12. The spot detecting method of claim 11, wherein there are two gap areas and two contrasting areas defined in each horizontally-oriented detecting area, the two gap areas are located at adjacent opposite horizontal sides of the test point, and the two contrasting areas are located next to the corresponding gap areas away from the test point.

13. The spot detecting method of claim 11, wherein there are two gap areas and two contrasting areas defined in each vertically-oriented detecting area, the two gap areas are located at adjacent opposite sides of the test point, and the two contrasting areas are located above and below the corresponding gap area away from the test point.

14. The spot detecting method of claim 11, wherein there are four gap areas and four contrasting areas defined in the center detecting area, the four gap areas are located at adjacent opposite horizontal sides and opposite vertical sides of the test point, and the four contrasting areas are located next to the corresponding gap areas away from the test point.

15. The spot detecting method of claim 11, wherein there are two gap areas and two contrasting areas defined in each corner area, the two gap areas are located at a horizontal side and a vertical side of the test point, respectively, and the two contrasting areas are located beside the corresponding gap areas away from the test point.

16. The spot detecting method of claim 11, wherein there are two gap areas and two contrasting areas defined in each horizontal area, the two gap areas are located at opposite horizontal sides of the test point, and the two contrasting areas are located at a side of corresponding gap area away from the test point.
